(19) United States
(12) Patent Application Publication
(10) Pub. No.: US 2020/0392938 A1
(43) Pub. Date: Dec. 17, 2020

(54) Volume-Distributed Multi-Blade Wind Turbine Design

(71) Applicant: University of Louisiana at Lafayette, Lafayette, LA (US)

(72) Inventor: Clint Bergeron, Carencro, LA (US)

(21) Appl. No.: 16/892,381

(22) Filed: Jun. 4, 2020

Related U.S. Application Data
(60) Provisional application No. 62/861,482, filed on Jun. 14, 2019.

(51) Int. Cl. F03D 1/06

(52) U.S. Cl. CPC F03D 1/0675

(57) ABSTRACT

This invention is a new wind turbine blade design for easier manufacture, improved angular speed control, and improved turbine efficiency. The invention comprises a plurality of scaled-down wind turbine blades arranged across a central spine frame to produce a feather-like pattern.

### CROSS REFERENCE TO RELATED APPLICATIONS

This application claims priority to the Provisional U.S. patent application No. 62/861,482 entitled “Volume Distribution for Wind Turbine Blade Design,” filed Jun. 14, 2019.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF THE INVENTION

This invention is a new wind turbine blade design for easier manufacture, improved angular speed control, and improved turbine efficiency. The novel design provides for more affordable and accessible wind turbines and outperforms the standard three-blade design in many performance categories.

The invention provides for scaling one or more wind turbine blades down by volume by at least 9 times. In other embodiments, the scale may be more or less than 9 times. The scaled down wings are located on a central spine frame to produce a feather-like pattern.

### DESCRIPTION OF THE DRAWINGS

The drawings constitute a part of this specification and include exemplary embodiments of the Volume-Distributed Multi-Blade Wind Turbine Design, which may be embodied in various forms. It is to be understood that in some instances, various aspects of the invention may be shown exaggerated or enlarged to facilitate an understanding of the invention. Therefore the drawings may not be to scale.

FIG. 1 is a depiction of the airfoil cross-section design.

FIG. 2 is the standard windmill design with constant 15-degree blade-angle to the forward normal used as a control.

FIG. 3 depicts the 9-by-3 design tested with constant 15-degree blade-angle to the forward normal in this study. The side blades are angled at 25 degrees from the radial spine direction.

FIG. 4 is a graph that shows the torque versus angular speed along with the power versus angular speed for both designs at 3.5 m/s wind speed and constant 15-degree angle to the forward normal.

FIG. 5a is a graph of wind turbine radius versus the angle of incidence of the wind, at various angular speeds, at specified the wind speeds, 6 m/s.

FIG. 5b is a graph of wind turbine radius versus the angle of incidence of the wind, at various angular speeds, at specified the wind speeds, 3 m/s.

### BACKGROUND

Renewable energy systems have provided a venue for correcting the course in energy production. Sustainability, efficiency, storage, and transport of energy are the key components of providing cost effective renewable energy solutions.

Wind turbines have an important role in renewable energy system solutions. Wind energy and wind turbine optimization techniques are known in the art. However, when manufacturing a large windmill, difficulties are found in assembling and transporting the wind turbine blades to the site where the wind turbine will be assembled. A more practical method to manufacture windmill blades and improve windmill efficiency is needed to make the development of wind turbine farms with larger windmills more economically feasible.

This invention presents a novel approach to wind turbine design. A new design for wind turbine blades is provided. The invention presents a scaled down stationary wind turbine wing that has an increased upward force per volume, with blade airfoil design, angle of attack, and wind speed being equal. This provides a more efficient and cost-effective manufacturing process.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

In one embodiment, this invention is an airfoil extruded into a wind turbine blade, with three blades placed at an optimal distance apart, for example, at 120 degrees apart, to produce a three-bladed wind turbine. Other distances may be used depending on wind condition and size of the blades. For example, between 100 and 150 degrees apart may be used. In one or more embodiments, the blades are oriented in a circular arrangement.

The invention further provides for scaling said wind turbine blade down by volume by at least 9 times. In other embodiments, the scale may be more or less than 9 times. The scaled down wings are located on a central spine frame to produce a feather-like pattern.

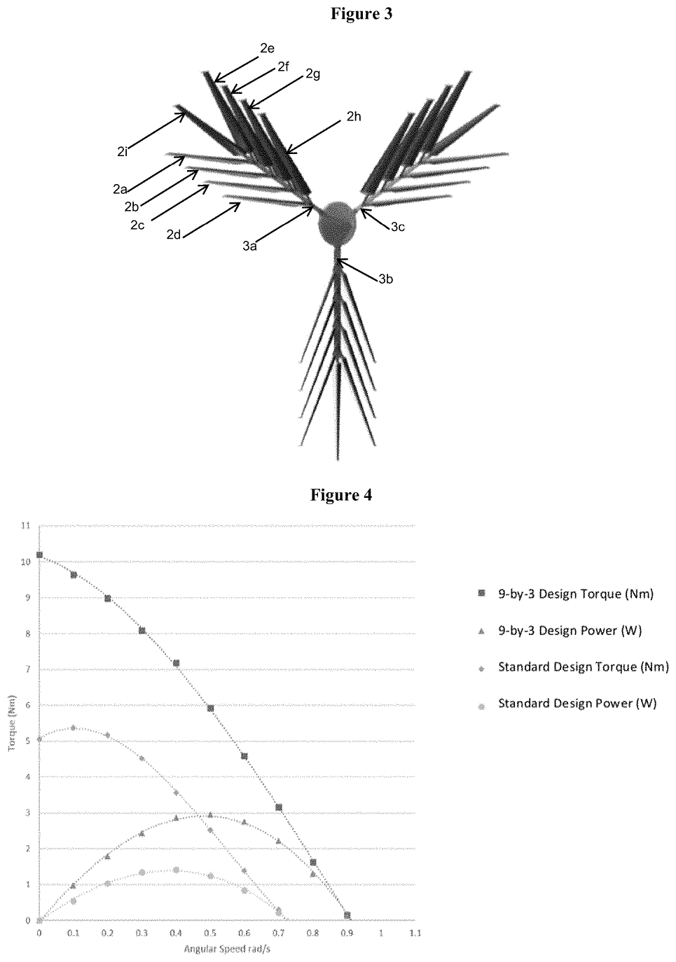

Three standard blades 1a,b,c were placed in a circular arrangement, 120 degrees from one another to produce a “standard” three-blade windmill orientation, as shown in FIG. 2. In FIG. 3, the same positioning was used for the central spine frames 3a,b,c.

FIG. 3 shows the novel invention, which integrates the scaled down blades. In the preferred embodiment, the standard blade—for example, 1a—was scaled down to one-ninth of the original volume, and nine of the scaled-down blades 2,a,b,c,d,e,f,g,h,i were arranged in a way to produce a new single blade 4. In this embodiment, each of the other two “standard” blades 1b, c are scaled down in a similar fashion.

In this embodiment, scaled down blades are positioned so that four 2a,b,c,d are along one side of the spine 3a and equidistant, four 2e,f,g,h are along the opposite side and equidistant, and one 2i is located at the tip of the spine 3a. The other two spines 3b,c and associated scaled-down blades are similar situated. The scaled-down blades are attached to the spine in any suitable manner. In one embodiment, the scaled-down blades are integral with the spine.

In other embodiments, the scaled-down blades may be configured differently around the spine, depending on the wind speed of the desired location, manufacturing process limitations, and other factors.

The airfoil chosen is mainly used for vertical axis wind turbines. However, other airfoils may be used. For instance, while the angle of the blades to the direction of the ambient wind was placed as a constant at 15 degrees in this example, horizontal axis wind turbines have a blade velocity that is proportional to the rotation rate or angular speed and increases with radial.

### Example 1

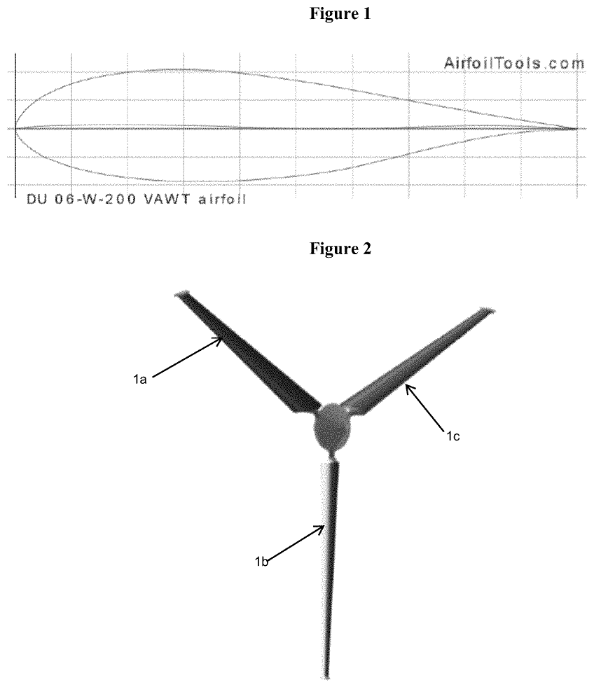

Modeling and simulation was done in Dassault Systems' SolidWorks. A DU 06-2-200 VAWT airfoil cross-section, shown in FIG. 1, was utilized to extrude a wind turbine blade.

A flow simulation was carried out on both wing sizes at a constant 15 degrees to the horizontal to record the resultant upward force. The flow simulation was carried out at two different wind speeds. At 3.5 m/s, the smaller blade resultant upward force was 0.267 N, while the larger blade simulation resulted in an upward force of 1.363 N, approximately 5 times greater. At 20 m/s, the smaller blade resultant upward force was 9.339 N, while the larger blade simulation resulted in an upward force of 45.032 N, approximately 5 times greater. This study showed that a wing scaled down nine times, in volume, produces more upward force per volume of wing, agreeing with the first hypothesis.

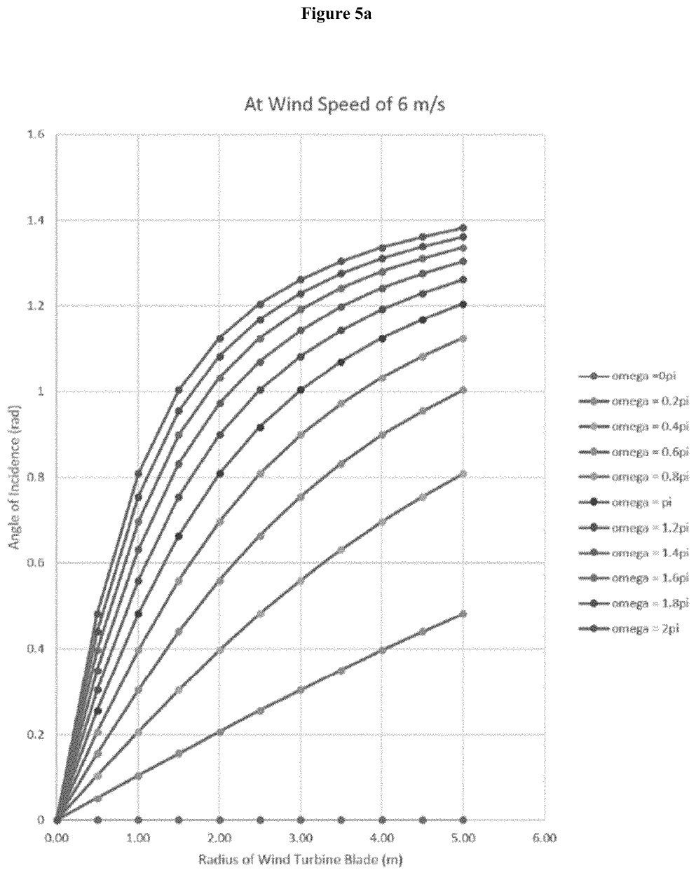

Computational fluid dynamics was performed with the windmills within a rotation region, where the rotation region angular speed was incrementally increased from 0 rad/s by 0.1 rad/s increments until the torque output reversed directions. The data was plotted, shown in FIG. 4, where the global torque and resulting power curves versus angular speed are shown. It was shown that the brake-torque (0 rad/s) of the proposed design at 3.5 m/s wind speed provides approximately 2 times the torque as the standard model and absorbs approximately 2 times the energy from the air as the standard model.

The low magnitude of the values is a result of not using an optimized windmill blade design. Also, it must be considered that the optimal angle to the forward normal changes with the wind speed, W, and the tangential speed, V, of the blade at some distance from the center, R, of the blade at some angular speed, ω, where V=ωR. The tip speed ratio, V/W, is used to characterize wind turbines at some chosen wind speed and resulting optimal ω. Accordingly, in one or more embodiments, the blades are controlled to rotate along its own long axis, which provides greater control over angular speed. Thus, a means for individual control of the blades may also be used.

W and V together, result in a relative velocity of the air to the blade. The angle between W and V, α, may be defined as:

$$α = a tan \frac{ω R}{W} , where$$

$${α}^{′} = \frac{d α}{d R} a tan \frac{ω R}{W} = \frac{ω}{W} \frac{1}{1 + {( \frac{ω R}{W} )}^{2}} ; therefore$$

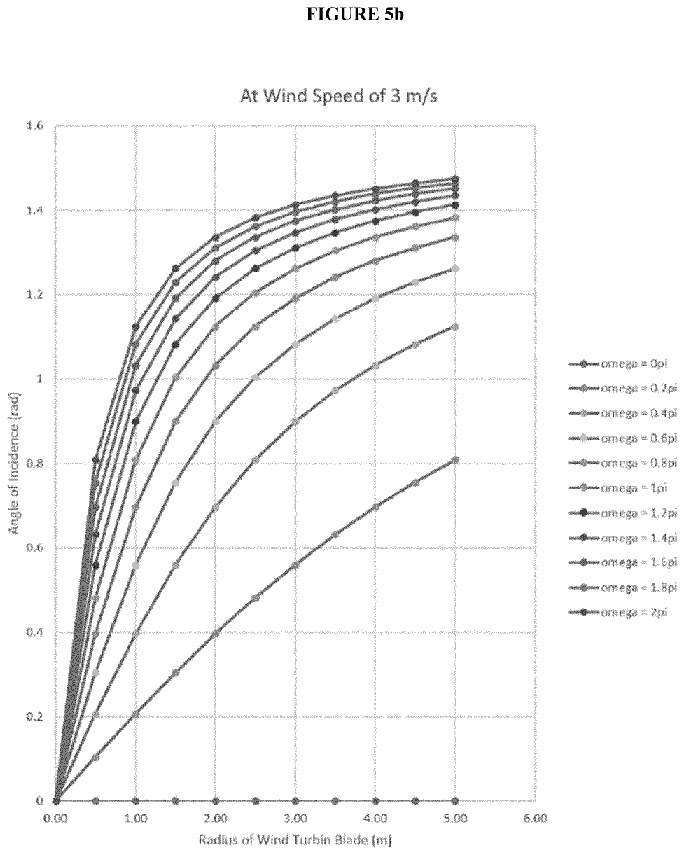

α′ is not a constant across R, but instead decreases with increasing R. A wind speed needs to be chosen for the design of the wind turbine, depending on where the wind turbine will be placed. An optimized lift-driven airfoil cross-section needs to be chosen for the wind turbine. FIG. 5 shows two graphs of angle of incidence, α, of the wind across the length of a wind turbine blade at various angular speeds and wind speeds of 3 m/s and 6 m/s. The optimal blade angle, 9, changes with α(R); therefore, given W, a stationary blade, with a constant blade angle 90, can be used to optimize the blade angle at the theoretical R=0 point, where

$$θ ( R ) = {θ}_{0} + a tan \frac{ω R}{W}$$

This formula may be used to optimize a common windmill turbine blade, given some airfoil cross-section design. The application of this concept on the proposed design becomes slightly more complex, where each blade needs to be designed according to its radial progression at the angle of the blade from the radial direction. The number of blades per blade on the proposed design needs to be optimized.

With the current 9-blade design, this angle from the radial needs to be optimized so that 5 different blades, four pairs and a single, can be fabricated for each full blade of the proposed design. To maintain the scaled-volume concept across the design, for fair comparison of performance, although blade angles may change per blade, 1/9 volume of the standard blade, for a 9-blade design, shall be maintained. Once the airfoil cross-section, the number of blades per blade, and the angle from the radial direction are optimized, an optimized blade of the proposed design may be constructed for the final analysis and comparison to its standard 3-blade counterpart.

For the purpose of understanding the Volume-Distributed Multi-Blade Wind Turbine Design, references are made in the text to exemplary embodiments of an Volume-Distributed Multi-Blade Wind Turbine Design, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. A wind turbine blade comprising:
a. at least one central spine structure; and
b. a plurality of scaled-down blades, said scaled-down blades volume being a set proportion less than a standard blade;
wherein said scaled-down blades are connected at one end to said central spine structure.

2. The wind turbine blade of claim 1 comprising nine scaled down wind turbines.

3. The wind turbine blade of claim 2 wherein said scaled-down blades volume is 1/9th of a standard blade.

4. The wind turbine blade of claim 1 wherein said plurality of scaled-down blades are arranged equidistant along said central spine structure.

5. A wind turbine comprising:
a. at least three central spine structures; and
b. a plurality of scaled-down blades, said scaled-down blades volume being a set proportion less than a standard blade;
wherein said scaled-down blades are arranged around each of said at least three central spine structures.

6. The wind turbine of claim 5 wherein said at least three central spine structures are 120 degrees apart.

7. The wind turbine of claim 5 wherein nine said scaled-down blades are arranged around each said at least three central spine structures.

8. The wind turbine blade of claim 7 wherein said scaled-down blades volume is 1/9th of a standard blade.
